(19) United States
(12) Patent Application Publication
(10) Pub. No.: US 2007/0214982 A1
(43) Pub. Date: Sep. 20, 2007

(54) Printing Cylinder for a Printing Press

(75) Inventors: Ralph Klarmann, Augsburg (DE); Thomas Weissbacher, Augsburg (DE); Christian Fuchs, Augsburg (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/687,369

(22) Filed: Mar. 16, 2007

(30) Foreign Application Priority Data
Mar. 17, 2006 (DE) 10 2006 012 288.7

(51) Int. Cl. B41G 7/00; B41L 47/02

(52) U.S. Cl. 101/368

(57) ABSTRACT

A printing cylinder for a printing press, specifically a web-fed printing press, is disclosed. The printing cylinder having an outer surface and at least one lockup slot introduced into the outer surface to clamp at least one printing form or at least one rubber blanket on the printing cylinder. The entire outer surface of the printing cylinder, including the, or each, lockup slot is evenly coated autocatalytically with nickel and phosphorus.

This application claims the priority of German Patent Document No. 10 2006 012 288.7, filed Mar. 17, 2006, the disclosure of which is expressly incorporated by reference herein.

### BACKGROUND AND SUMMARY OF THE INVENTION

The invention relates to a printing cylinder for a printing press, specifically for a rotary web press.

From German Patent Document No. DE 103 49 446 B4 a printing cylinder for a printing press is known having an outer surface and a lockup slot introduced into the outer surface, wherein the lockup slot serves to clamp a printing plate, or a rubber blanket, on the outer surface of the print cylinder. In order to increase the wear resistance of the printing cylinder, DE 103 49 446 B4 proposes coating the inner surface of the lockup slot, specifically with a chemical, or also an autocatalytic deposition of nickel and phosphorus. In the area of the outer surface, that is to say outside of the, or each, lockup slot, the printing cylinder known from DE 103 49 446 B4 is either not coated or is coated with a different coating.

With this as the point of departure, the problem confronting the present invention is to create a novel printing cylinder for a printing press, specifically for a rotary web press. In accordance with the invention, the entire outer surface of the printing cylinder, including the, or each, lockup slot, is autocatalytically coated with nickel and phosphorus.

Within the meaning of the present invention, it is provided that the entire outer surface of the printing cylinder, including the, or each, lockup slot, that is to say the interior surface of the, or each, lockup slot be evenly coated autocatalytically with nickel and phosphorus.

Using this method, it is possible to coat the printing cylinder evenly precisely to contour and without reworking. The outer surface area and the geometry of the, or each, lockup slot is coated in a single coating step. It is thereby possible to coat printing cylinders simply and economically with wear protection coatings, and/or corrosion protection coatings.

Preferably the entire outer surface of the printing cylinder, including the, or each, lockup slot, is coated with a dispersion coating from a nickel-phosphorus matrix having ceramic particles and/or lubricating particles embedded in the nickel-phosphorus matrix.

Preferred refinements of the invention can be derived from the description hereinafter. Embodiments of the invention are explained in more detail with reference to the drawing, without necessarily being restricted thereto.

### BRIEF DESCRIPTION OF THE DRAWING

FIG. 1 show a schematized illustration of a printing cylinder.

### DETAILED DESCRIPTION OF THE DRAWING

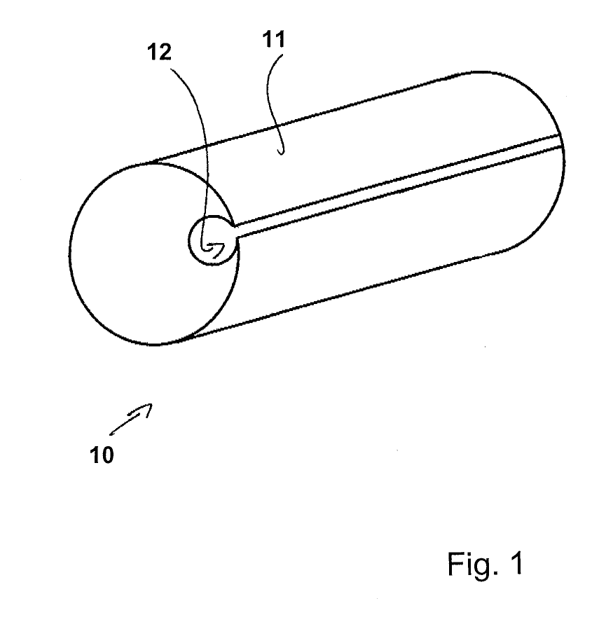

FIG. 1 show a highly schematized illustration of a printing cylinder 10, which has an outer surface 11 and a lockup slot 12 introduced into the outer surface 11.

In the sense of the present invention, the entire printing cylinder 10, particularly in the area of its outer surface 11 and in the area of its lockup slot 12, is evenly coated autocatalytically or chemically with nickel and phosphorus. In this manner, in the case of the printing cylinder in accordance with the invention, the outer surface 11, as well as an inner surface of the lockup slot 12 is coated with the same material to the same film thickness.

Preferably the even coating of the outer surface 11 of the printing cylinder 10 and of the lockup slot 12 of same is made up of a dispersion coating consisting of a nickel-phosphorus matrix with ceramic particles and/or lubricating particles embedded in the nickel-phosphorus matrix.

If ceramic particles are then embedded in the nickel-phosphorus matrix of the dispersion coating, they are preferably configured as particles of silicon carbide (SiC) and/or boron carbide (B₄C) and/or diamond-like carbon (DLC).

If lubricating particles are then integrated into the nickel-phosphorus matrix of the dispersion coating, they are preferably configured as particles of polytetrafluoroethylene (PTFE) and/or perfluoroethylene copolymer (FEP) and/or perfluoralkoxy copolymer (PFA).

### REFERENCE NUMERAL LIST

Printing cylinder
Outer surface
Lockup slot

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing cylinder for a printing press, specifically a rotary web press, having an outer surface and at least one lockup slot introduced into the outer surface for at least one printing form or at least one rubber blanket on the printing cylinder, wherein the entire outer surface of the printing cylinder, including the, or each, lockup slot, is evenly coated autocatalytically with nickel and phosphorus.

2. The printing cylinder according to claim 1, wherein the entire outer surface of the printing cylinder, including the, or each, lockup slot is coated with a dispersion coating consisting of a nickel-phosphorus matrix having ceramic particles and/or lubricating particles evenly embedded in the nickel-phosphorus matrix.

3. The printing cylinder according to claim 2, wherein a carbide is embedded in the nickel-phosphorus matrix as a ceramic particle.

4. The printing cylinder according to claim 3, wherein silicon carbide (SiC) and/or boron carbide (B₄C) is embedded in the nickel-phosphorus matrix.

5. The printing cylinder according to claim 2, wherein polytetrafluoroethylene (PTFE) and/or perfluoroethylene propylene copolymer (FEP) and/or perfluoralkoxy copolymer (PFA) is embedded in the nickel-phosphorus matrix as a lubricating particle.

6. A printing cylinder for a printing press, comprising:
a cylinder having an outer surface, wherein the cylinder defines a slot extending along a length of the cylinder; and
a nickel and phosphorus coating disposed on the outer surface and within the slot.

7. The printing cylinder according to claim 6, wherein a same thickness of the nickel and phosphorus coating is disposed on the outer surface and within the slot.

8. The printing cylinder according to claim 6, further comprising a ceramic particle embedded in the nickel and phosphorus coating.

9. The printing cylinder according to claim 8, wherein the ceramic particle is a carbide or a diamond-like carbon.

10. The printing cylinder according to claim 6, further comprising a lubricating particle embedded in the nickel and phosphorus coating.

11. The printing cylinder according to claim 10, wherein the lubricating particle is a polytetrafluoroethylene (PTFE), or a perfluoroethylene propylene copolymer (FEP), or a perfluoralkoxy copolymer (PFA).

12. The printing cylinder according to claim 6, further comprising a printing form or a rubber blanket disposed within the slot and on the outer surface.

13. A method of manufacturing a printing cylinder for a printing press, wherein the printing cylinder has an outer surface and wherein the printing cylinder defines a slot extending along a length of the printing cylinder, comprising the step of:
coating nickel and phosphorus on the outer surface of the printing cylinder and within the slot of the printing cylinder.

14. The method according to claim 13, wherein the nickel and phosphorus are coated autocatalytically on the outer surface of the printing cylinder and within the slot of the printing cylinder.

15. The method according to claim 13, wherein the nickel and phosphorus are coated on the outer surface of the printing cylinder and within the slot of the printing cylinder in a single process step.

16. The method according to claim 13, wherein the nickel and phosphorus are coated on the outer surface of the printing cylinder and within the slot of the printing cylinder to a same thickness.

17. The method according to claim 13, further comprising the step of embedding a ceramic particle in the nickel and phosphorus.

18. The method according to claim 17, wherein the ceramic particle is a carbide or a diamond-like carbon.

19. The method according to claim 13, further comprising the step of embedding a lubricating particle in the nickel and phosphorus.

20. The method according to claim 19, wherein the lubricating particle is a polytetrafluoroethylene (PTFE), or a perfluoroethylene propylene copolymer (FEP), or a perfluoralkoxy copolymer (PFA).
